(19) United States
(12) Patent Application Publication
(10) Pub. No.: US 2013/0038816 A1
(43) Pub. Date: Feb. 14, 2013

(54) LIQUID CRYSTAL DISPLAY DEVICE AND LIGHT GUIDE PLATE THEREOF

(71) Applicants: Shao-Keng HUANG, Taoyuan County (TW); Cheng-Min Liao, Taoyuan County (TW); Ching-Lung Chang, Taoyuan County (TW)

(72) Inventors: Shao-Keng HUANG, Taoyuan County (TW); Cheng-Min Liao, Taoyuan County (TW); Ching-Lung Chang, Taoyuan County (TW)

(73) Assignee: CHUNGHWA PICTURE TUBES, LTD., Taoyuan (TW)

(21) Appl. No.: 13/401,202

(22) Filed: Feb. 21, 2012

(30) Foreign Application Priority Data
Aug. 9, 2011 (TW) 100214760

(51) Int. Cl. G02F 1/13357; F21V 8/00

(52) U.S. Cl. 349/65; 362/621

(57) ABSTRACT

A light guide plate comprises two supporting bars and a light transmission plate. Each of the supporting bars includes a wall and a first supporting protruded element. Each of the walls has a wall surface, which face each other. Each of the first supporting protruded elements is connected to one of the walls, and is protruded outside the wall surface. The light transmission plate has a light exiting surface, a light entering side surface and a bottom surface. The light exiting surface is disposed oppositely to the bottom surface, and the light entering side surface is connected between the light exiting surface and the bottom surface. The light transmission plate is connected between the supporting bars. Each of the first supporting protruded elements is disposed above the light exiting surface, and a first gap is disposed between each of the first supporting protruded elements and the light exiting surface.

### CROSS-REFERENCE TO RELATED APPLICATION

This application claims the benefit of Taiwan Patent Application No. 100214760, filed on Aug. 9, 2011, which is hereby incorporated by reference for all purposes as if fully set forth herein.

### BACKGROUND OF THE DISCLOSURE

1. Field of Disclosure

The present disclosure relates to a display device and more particularly to a liquid crystal display device and a light guide plate thereof.

2. Related Art

Nowadays many portable electronic devices such as laptops, tablet computers, mobile phones and smart mobile phones employ liquid crystal display modules (LCM) as the display screens.

A common liquid crystal display module comprises a liquid crystal panel, a backlight module and a frame component. The liquid crystal panel and the backlight module are installed inside the frame component. With the frame component, the liquid crystal panel is fixed on the backlight module, so that the light emitted from the backlight module can be transmitted through the liquid crystal panel.

For consumer's convenience in carrying portable electronic devices, the products are getting more compact in size to meet the trend of development. Therefore, many manufacturers of portable electronic devices endeavor to research and develop smaller portable electronic devices to meet the demands and requirements of users.

### SUMMARY OF THE DISCLOSURE

A light guide plate of the present disclosure can be combined with a liquid crystal panel and an optical film.

A liquid crystal display device of the present disclosure can help to reduce the sizes of current portable electronic devices.

A light guide plate of the present disclosure comprises two supporting bars and a light transmission plate. Each of the supporting bars includes a wall and a first supporting protruded element, wherein each of the walls has a wall surface, and the wall surfaces face each other. Each of the first supporting protruded elements is connected to one of the walls, and is protruded outside the wall surface. The light transmission plate has a light exiting surface, a light entering side surface and a bottom surface, wherein the light exiting surface is opposite to the bottom surface, and the light entering side surface is connected between the light exiting surface and the bottom surface. The light transmission plate is connected between the supporting bars, wherein each of the first supporting protruded elements is disposed above the light exiting surface, and a first gap is located between each of the first supporting protruded elements and the light exiting surface.

The present disclosure also provides a liquid crystal display device which comprises the abovementioned light guide plate, a liquid crystal panel and at least one optical film. The liquid crystal panel is disposed on the first supporting protruded elements. The optical film is disposed inside the first gaps.

By employing the abovementioned supporting protruded elements (e.g. the first supporting protruded elements) and the gaps (e.g. the first gaps), both of the liquid crystal panel and the optical film can be combined with the light guide plate of the present disclosure. Thus, the present disclosure can reduce the number of elements of the current liquid crystal displays and therefore reduce the sizes of portable electronic devices.

The present disclosure will be fully understood by reference to the following detailed description thereof when read in conjunction with the attached drawings.

### BRIEF DESCRIPTION OF THE DRAWINGS

FIG. 1A is a planform view of a liquid crystal display device according to a first embodiment of the present disclosure;

FIG. 1B is a cross-sectional view along line I-I of FIG. 1A;

FIG. 2A is a planform view of a liquid crystal display device according to a second embodiment of the present disclosure; and

FIG. 2B is a cross-sectional view along line II-II of FIG. 2A.

### DETAILED DESCRIPTION OF THE DISCLOSURE

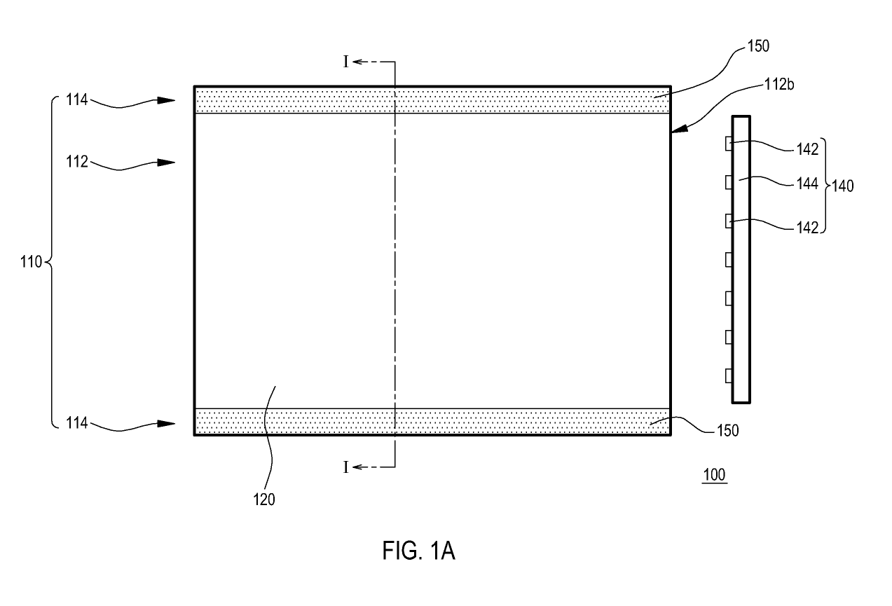

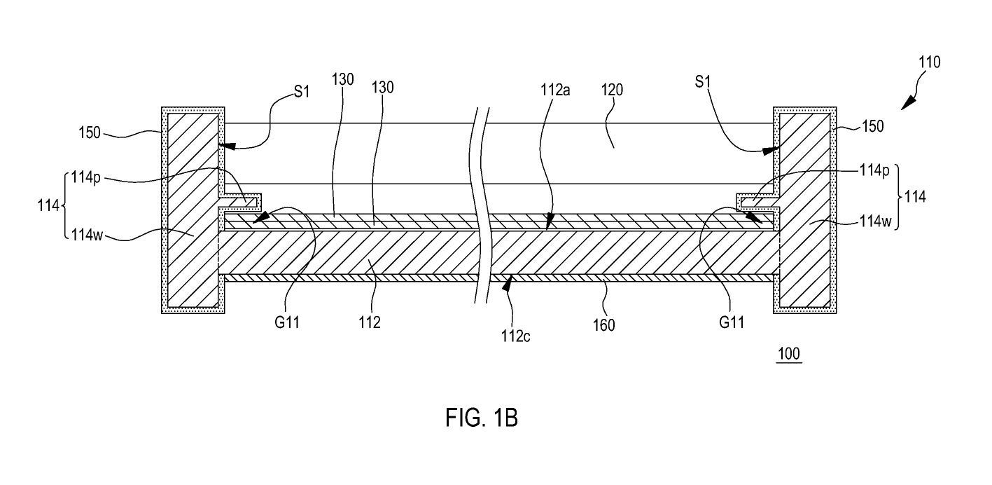

FIG. 1A shows a planform view of a liquid crystal display device according to a first embodiment of the present disclosure, and FIG. 1B is a cross-sectional view along line I-I of FIG. 1A. Referring to FIGS. 1A and 1B, a liquid crystal display device 100 of the embodiment comprises a light guide plate 110, a liquid crystal panel 120, a plurality of optical films 130 and a light emitting element 140. The light guide plate 110 can be combined with the liquid crystal panel 120 and the optical film 130. The light emitting element 140 is disposed beside the light guide plate 110. The optical films 130 are, for example, diffusers and/or brightness enhancement films.

The light guide plate 110 comprises a light transmission plate 112 and two supporting bars 114, wherein the supporting bars 114 are disposed oppositely to each other, and the light transmission plate 112 is connected between the supporting bars 114. The function of the light transmission plate 112 is the same as that of a light guide plate of a current liquid crystal display device. In other words, the light transmission plate 112 can guide the light emitted from the light emitting element 140, and can transmit the light to the optical films 130 and the liquid crystal panel 120.

The light transmission plate 112 has a light exiting surface 112a, a light entering side surface 112b and a bottom surface 112c; the light exiting surface 112a is opposite to the bottom surface 112c, and the light entering side surface 112b is connected between the light exiting surface 112a and the bottom surface 112c. The liquid crystal panel 120 and the optical films 130 are disposed above the light exiting surface 112a. The light emitting element 140 is disposed beside the light entering side surface 112b.

The light emitting element 140 can include a plurality of light emitting units 142 and a circuit board 144, wherein the light emitting units 142 are mounted on the circuit board 144, and can emit light towards the light entering side surface 112b. Furthermore, for example the light emitting units 142 can be light emitting diodes (LED), and the circuit board 144 can be a flexible circuit board or a rigid circuit board.

Light can be transmitted through the light transmission plate 112. When the light emitting units 142 emit light towards the light entering side surface 112b, the light enters into the light transmission plate 112 via the light entering side surface 112b. Then, the light will be reflected in the inside of the light transmission plate 112 and be emitted from the light exiting surface 112a. This indicates that, the light transmission plate 112 can guide the light emitted from the light emitting element 140, so that the light can be transmitted through the optical films 130 and the liquid crystal panel 120 in order.

The supporting bars 114 are used to support the liquid crystal panel 120. More specifically, each of the supporting bars 114 includes a wall 114w and a first supporting protruded element 114p. Each of the first supporting protruded elements 114p is connected to one of the walls 114w. Each of the walls 114w has a wall surface S1. Each of the first supporting protruded elements 114p is disposed on one of the wall surfaces S1 and is protruded outside the wall surface S1. Furthermore, the wall surfaces S1 face each other, and thus the first supporting protruded elements 114p are disposed oppositely to each other.

The light exiting surface 112a is disposed between the walls S1, and each of the first supporting protruded elements 114p is disposed above the light exiting surface 112a. The liquid crystal panel 120 is disposed on the first supporting protruded elements 114p, and thus the first supporting protruded elements 114p support the liquid crystal panel 120. Furthermore, there is a first gap G11 located between each of the first supporting protruded elements 114p and the light exiting surface 112a, and the optical films 130 are disposed in the first gaps G11 as shown in FIG. 1B. This indicates that, by employing the first supporting protruded elements 114p and the first gaps G11, the liquid crystal panel 120 and the optical films 130 can be combined with the light guide plate 110.

In the embodiment shown in FIG. 1B, the liquid crystal display device 100 comprises a plurality of optical films 130; but in other embodiments, the liquid crystal display device 100 only comprises one optical film 130. Therefore, number of the optical film 130 is not a limitation of the present disclosure.

The light transmission plate 112 and the supporting bars 114 can be made of the same material and formed in the same process. For example, the light transmission plate 112 and the supporting bars 114 can be made of transparent polymer such as polymethylmethacrylate (PMMA), aka acrylic. The light transmission plate 112 and the supporting bars 114 can be formed by an injection molding of the same transparent polymer material in the same manufacturing process. Therefore, the light transmission plate 112 and the supporting bars 114 can be formed integrally in one piece, so that the light exiting surface 112a can be connected to and in contact with the wall surfaces S1.

The liquid crystal display device 100 can also comprise a plurality of light screening layers 150, and the light screening layers 150 cover the supporting bars 114 and expose the light transmission plate 112. The light screening layers 150 are non-transparent. For examples, the light screening layers 150 can be a coating layer formed by a coating material (such as black printing ink, gray printing ink or white printing ink), or non-transparent black tape, gray tape or white tape. Therefore, basically the light screening layers 150 do not allow light to transmit therethrough, so as to reduce the possibility of light leakage.

Although the liquid crystal display device 100 can comprise the light screening layers 150 to cover the supporting bars 114; in other embodiments, the liquid crystal display device 100 does not have the light screening layers 150. More specifically, in other embodiments, the supporting bars 114 can be non-transparent, and thus the supporting bars 114 can be made of non-transparent polymer material.

The abovementioned non-transparent polymer material can be polycarbonate (PC) or acrylonitrile butadiene styrene resin (ABS resin). Since the supporting bars 114 can be non-transparent; even if the supporting bars 114 are not covered by any of the light screening layers 150, basically the non-transparent supporting bars 114 do not allow light to transmit therethrough. This indicates that, the light screening layers 150 shown in FIG. 1B are only for description as an example, but not as a limitation of the present disclosure.

In this embodiment, the light transmission plate 112 is made of transparent polymer material and the supporting bars 114 can be made of non-transparent polymer material; but both of the light transmission plate 112 and the supporting bars 114 can still be formed in the same manufacturing process. For example, the light transmission plate 112 and the supporting bars 114 can be formed by the manufacturing process of dual-material injection molding. Although the materials for manufacturing the light transmission plate 112 and the supporting bars 114 are different, the light transmission plate 112 and the supporting bars 114 can still be formed integrally in one piece.

Furthermore, when the liquid crystal display device 100 is employed in portable electronic devices such as laptops, tablet computers, mobile phones or smart mobile phones; the light screening layers 150 and the supporting bars 114 can be exposed as external parts of portable electronic devices. In other words, parts of surfaces of the light screening layers 150 and the supporting bars 114 can become parts of outside surfaces of portable electronic devices.

The liquid crystal display device 100 can also comprise a reflective sheet 160. The reflective sheet 160 can reflect light and is disposed below the light transmission plate 112. The reflective sheet 160 is opposite to the bottom surface 112c. When the light emitting units 142 emit light, the reflective sheet 160 reflects the light from the bottom surface 112c, so that the light emitted from the light emitting element 140 can be effectively and fully utilized.

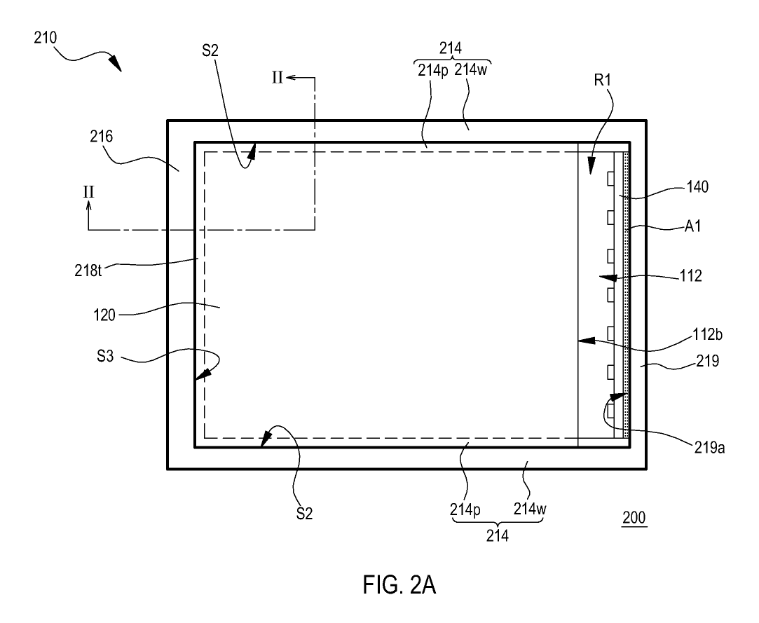

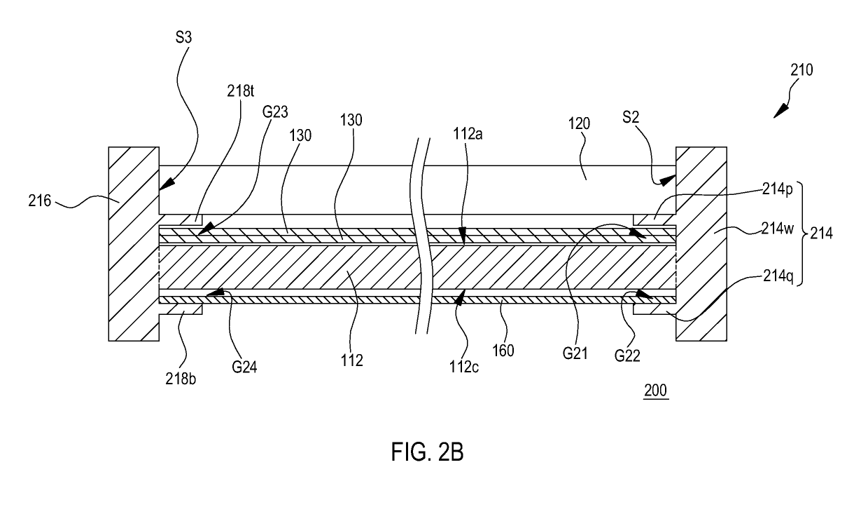

FIG. 2A shows a planform view of a liquid crystal display device according to a second embodiment of the present disclosure, and FIG. 2B is a cross-sectional view along line II-II of FIG. 2A. Referring to FIGS. 2A and 2B, a liquid crystal display device 200 of this embodiment is similar to the liquid crystal display device 100 of the first embodiment. The second embodiment comprises some elements the same as the first embodiment does. For example, the liquid crystal panel 120, a plurality of the optical films 130, the light emitting element 140 and the reflective sheet 160. However, there are some differences between the liquid crystal display device 100 and the liquid crystal display device 200, and the differences will be described below.

The liquid crystal display device 200 comprises a light guide plate 210, and the light guide plate 210 includes the light transmission plate 112 and two supporting bars 214. The supporting bars 214 are disposed oppositely to each other. The light transmission plate 112 is connected between the supporting bars 214. The supporting bars 214 in the second embodiment are structurally different from the supporting bars 114 in the first embodiment. More specifically, each of the supporting bars 214 not only includes a wall 214w and a first supporting protruded element 214p, but also has a second supporting protruded element 214q.

Each of the first supporting protruded elements 214p and each of the second supporting protruded elements 214q are connected to one of the walls 214w. Each of the walls 214w has a wall surface S2, and each of the first supporting protruded elements 214p and each of the second supporting protruded elements 214q are protruded outside the wall S2. The walls S2 face each other. Therefore, the first supporting protruded elements 214p are disposed oppositely to each other, and the second supporting protruded elements 214q are also disposed oppositely to each other.

Each of the first supporting protruded elements 214p is disposed above the light exiting surface 112a of the light transmission plate 112, and each of the second supporting protruded elements 214q is disposed below the bottom surface 112c of the light transmission plate 112. Therefore, the light transmission plate 112 is disposed between the first supporting protruded elements 214p and the second supporting protruded elements 214q. Furthermore, the liquid crystal panel 120 is disposed on the first supporting protruded elements 214p.

A first gap G21 is disposed between each of the first supporting protruded elements 214p and the light exiting surface 112a, and the optical films 130 are disposed in the first gaps G21. A second gap G22 is disposed between each of the second supporting protruded elements 214q and the bottom surface 112c, and the reflective sheet 160 is disposed in the second gaps G22. Therefore, the light transmission plate 112 is also disposed between the reflective sheet 160 and the optical films 130. By employing the first supporting protruded elements 214p, the first gaps G21 and the second gaps G22, the light guide plate 210 can be combined with the liquid crystal panel 120, the optical films 130 and the reflective sheet 160.

The light transmission plate 112 and the supporting bars 214 can be made of different materials. For example, the light transmission plate 112 can be made of transparent polymer such as polymethylmethacrylate (PMMA). The supporting bars 214 can be made of non-transparent polymer material such as polycarbonate (PC) or acrylonitrile butadiene styrene resin (ABS resin). Therefore, the supporting bars 214 can be non-transparent; and basically the supporting bars 214 do not allow light to transmit therethrough, in order to reduce the possibility of light leakage.

Furthermore, both of the light transmission plate 112 and the supporting bars 214 can still be formed in the same manufacturing process. For example, the light transmission plate 112 and the supporting bars 214 can be formed by the manufacturing process of dual-material injection molding. Although the materials for manufacturing the light transmission plate 112 and the supporting bars 214 are different, the light transmission plate 112 and the supporting bars 214 can still be formed integrally in one piece, and the light exiting surface 112a can be connected to and in contact with the wall surfaces S2.

The light guide plate 210 can also include a connecting bar 216, an upper protruded element 218t and a lower protruded element 218b. The connecting bar 216 is connected between the supporting bars 214 and is also connected to the light transmission plate 112. The supporting bars 214 and the connecting bar 216 surround the light transmission plate 112. The connecting bar 216 has a side surface S3; both the upper protruded element 218t and the lower protruded element 218b are connected to the connecting bar 216, and are protruded outside the side surface S3.

The upper protruded element 218t is disposed above the light exiting surface 112a, and the lower protruded element 218b is disposed below the bottom surface 112c. Therefore, the light transmission plate 112 is also disposed between the upper protruded element 218t and the lower protruded element 218b. Both of the upper protruded element 218t and the lower protruded element 218b are not in contact with the light transmission plate 112, therefore a gap G23 is disposed between the upper protruded element 218t and the light exiting surface 112a, and a gap G24 is disposed between the lower protruded element 218b and the bottom surface 112c. The optical films 130 can also be disposed in the gap G23, and the reflective sheet 160 can also be disposed in the gap G24.

Referring to FIG. 2A, the light guide plate 210 can also include a board element 219. The board element 219 is connected between the supporting bars 214 and is disposed oppositely to the light entering side surface 112b. The board element 219 has a board surface 219a being opposite to the light entering side surface 112b. An accommodating space R1 is disposed between the board surface 219a and the light entering side surface 112b. The light emitting element 140 is disposed on the board surface 219a and inside the accommodating space R1. The light emitting element 140 can be glued on the board surface 219a by a heat dissipation adhesive A1. Thus, the heat dissipation adhesive A1 can be used to mount the light emitting element 140 on the board surface 219a, and transfer the heat produced by the light emitting element 140.

The connecting bar 216, the upper protruded element 218t, the lower protruded element 218b and the board element 219 can be made of the same material of the supporting bars 214. In other words, the connecting bar 216, the upper protruded element 218t, the lower protruded element 218b and the board element 219 can be made of non-transparent polymer material such as polycarbonate (PC) or acrylonitrile butadiene styrene resin (ABS resin). Therefore, the connecting bar 216, the upper protruded element 218t, the lower protruded element 218b and the board element 219 can be non-transparent in order to reduce the possibility of light leakage.

Furthermore, the connecting bar 216, the upper protruded element 218t, the lower protruded element 218b, the board element 219, the supporting bars 214 and the light transmission plate 112 can be formed integrally in one piece. For example, the light transmission plate 112, the supporting bars 214, the connecting bar 216, the upper protruded element 218t, the lower protruded element 218b and board element 219 can be formed by the manufacturing process of dual-material injection molding. Therefore, the side surface S3 of the connecting bar 216 not only can be connected to the light exiting surface 112a, but also can be in contact with the light exiting surface 112a.

Although the light screening layers 150 shown in FIG. 1B are not shown in FIGS. 2A and 2B; in other embodiments, the liquid crystal display device 200 can comprise a plurality of the light screening layers 150 which cover the supporting bars 214, the connecting bar 216, the upper protruded element 218t, the lower protruded element 218b and the board element 219 respectively. Therefore, even if the supporting bars 214, the connecting bar 216, the upper protruded element 218t, the lower protruded element 218b and the board element 219 are made of transparent polymer material such as polymethylmethacrylate (PMMA), they can still be covered with the light screening layers 150, in order to reduce the possibility of light leakage. In other words, the light screening layers 150 of the first embodiment can also be applied in the second embodiment.

Furthermore, when the liquid crystal display device 200 is employed in portable electronic devices, the supporting bars 214, the connecting bar 216 and the board element 219 can be exposed as external parts of portable electronic devices. In other words, parts of surfaces of the supporting bars 214, the connecting bar 216 and the board element 219 can become parts of outside surfaces of portable electronic devices.

As a conclusion from the abovementioned, by employing the supporting protruded elements (e.g. the first supporting protruded elements) and the gaps (e.g. the first gaps), the liquid crystal panel and the optical films can be combined with the light guide plate of the present disclosure. Compared with ordinary liquid crystal display devices, the liquid crystal display device of the present disclosure can combine the liquid crystal panel, the optical films and the light guide plate together without frames. Thus, the present disclosure can reduce the number of elements of a liquid crystal display device and reduce sizes of portable electronic devices. Therefore, the development trend of compact sized portable electronic devices is met.

Note that the specifications relating to the above embodiments should be construed as exemplary rather than as limitative of the present disclosure, with many variations and modifications being readily attainable by a person of average skill in the art without departing from the spirit or scope thereof as defined by the appended claims and their legal equivalents.

What is claimed is:

1. A light guide plate comprising:
two supporting bars, each of the supporting bars comprising a wall and a first supporting protruded element, wherein each of the walls has a wall surface, the wall surfaces face each other, and each of the first supporting protruded elements is connected to one of the walls and is protruded outside the wall surface; and
a light transmission plate having a light exiting surface, a light entering side surface and a bottom surface, wherein the light exiting surface is opposite to the bottom surface, the light entering side surface is connected between the light exiting surface and the bottom surface, the light transmission plate is connected between the supporting bars, each of the first supporting protruded elements is disposed above the light exiting surface, and a first gap is disposed between each of the first supporting protruded elements and the light exiting surface.

2. The light guide plate as claimed in claim 1, wherein the light exiting surface is connected to and in contact with the wall surfaces.

3. The light guide plate as claimed in claim 1, wherein the supporting bars are non-transparent.

4. The light guide plate as claimed in claim 1, further comprising a plurality of light screening layers, wherein the light screening layers cover the supporting bars and expose the light transmission plate.

5. The light guide plate as claimed in claim 1, wherein each of the supporting bars further comprises a second supporting protruded element, each of the second supporting protruded elements is connected to one of the walls and is protruded outside the wall surface, the light transmission plate is disposed between the first supporting protruded elements and the second supporting protruded elements, and a second gap is disposed between each of the second supporting protruded elements and the bottom surface.

6. The light guide plate as claimed in claim 1, further comprising a board element, connected between the supporting bars and disposed oppositely to the light entering side surface, wherein the board element has a board surface being opposite to the light entering side surface, and an accommodating space is disposed between the board surface and the light entering side surface.

7. The light guide plate as claimed in claim 1, further comprising a connecting bar connected between the supporting bars and also connected to the light transmission plate, wherein the supporting bars and the connecting bar surround the light transmission plate.

8. The light guide plate as claimed in claim 7, further comprising an upper protruded element, wherein the connecting bar has a side surface, the side surface is connected to and in contact with the light exiting surface, the upper protruded element is connected to the connecting bar and is protruded outside the side surface, and the upper protruded element is disposed above the light exiting surface and is not in contact with the light transmission plate.

9. The light guide plate as claimed in claim 8, further comprising a lower protruded element connected to the connecting bar, wherein the lower protruded element is protruded outside the side surface, disposed below the bottom surface, and not in contact with the light transmission plate.

10. A liquid crystal display device comprising:
a light guide plate, comprising:
two supporting bars, each of the supporting bars comprising a wall and a first supporting protruded element, wherein each of the walls has a wall surface, the wall surfaces face each other, and each of the first supporting protruded elements is connected to one of the walls and is protruded outside the wall surface;
a light transmission plate having a light exiting surface, a light entering side surface and a bottom surface, wherein the light exiting surface is opposite to the bottom surface, the light entering side surface is connected between the light exiting surface and the bottom surface, the light transmission plate is connected between the supporting bars, each of the first supporting protruded elements is disposed above the light exiting surface, and a first gap is disposed between each of the first supporting protruded elements and the light exiting surface;
a liquid crystal panel disposed on the first supporting protruded elements; and
at least one optical film disposed in the first gaps.

11. The liquid crystal display device as claimed in claim 10, wherein the light exiting surface is connected to and in contact with the wall surfaces.

12. The liquid crystal display device as claimed in claim 10, wherein the supporting bars are non-transparent.

13. The liquid crystal display device as claimed in claim 10, wherein the light guide plate comprises a plurality of light screening layers, and the light screening layers cover the supporting bars and expose the light transmission plate.

14. The liquid crystal display device as claimed in claim 10, further comprising a reflective sheet disposed below the light transmission plate and being opposite to the bottom surface.

15. The liquid crystal display device as claimed in claim 14, wherein each of the supporting bars further comprises a second supporting protruded element, each of the second supporting protruded elements is connected to one of the walls and is protruded outside the wall surface, the light transmission plate is disposed between the first supporting protruded elements and the second supporting protruded elements, and a second gap is disposed between each of the second supporting protruded elements and the bottom surface, and the reflective sheet is disposed in the second gaps.

16. The liquid crystal display device as claimed in claim 10, further comprising a light emitting element disposed beside the light entering side surface.

17. The liquid crystal display device as claimed in claim 16, wherein the light guide plate further comprises a board element connected between the supporting bars, and disposed oppositely to the light entering side surface, wherein the board element has a board surface being opposite to the light entering side surface, an accommodating space is disposed between the board surface and the light entering side surface, and the light emitting element is disposed on the board surface and is inside the accommodating space.

18. The liquid crystal display device as claimed in claim 10, wherein the light guide plate further comprises a connecting bar connected between the supporting bars and also connected to the light transmission plate, and the supporting bars and the connecting bar surround the light transmission plate.

19. The liquid crystal display device as claimed in claim 18, wherein the light guide plate further comprises an upper protruded element, the connecting bar has a side surface connected to and being in contact with the light exiting surface, and the upper protruded element is connected to the connecting bar and is protruded outside the side surface, the upper protruded element is disposed above the light exiting surface and is not in contact with the light transmission plate.

20. The liquid crystal display device as claimed in claim 19, wherein the light guide plate further comprises a lower protruded element connected to the connecting bar and protruded outside the side surface, disposed below the bottom surface, and being not in contact with the light transmission plate.
